(19) United States
(12) Patent Application Publication
(10) Pub. No.: US 2023/0238539 A1
(43) Pub. Date: Jul. 27, 2023

(54) LITHIUM SECONDARY BATTERY, AND ANODE FREE BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/127,948

(22) Filed: Mar. 29, 2023

Related U.S. Application Data
(63) Continuation of application No. PCT/JP2020/037201, filed on Sep. 30, 2020.

(51) Int. Cl. H01M 4/62; H01M 4/38; H01M 4/13; H01M 10/44; H01M 4/36; H01M 10/0585; H01M 4/02

(52) U.S. Cl. CPC H01M 4/628; H01M 4/38; H01M 4/13; H01M 10/44; H01M 4/366; H01M 10/0585; H01M 2004/028; H01M 2004/027

(57) ABSTRACT

The present invention provides a lithium secondary battery that has high energy density and capacity and has excellent cycle characteristics. The present invention relates to a lithium secondary battery including a positive electrode current collector, a negative electrode that is free of a negative electrode active material, a separator that is disposed between the positive electrode current collector and the negative electrode, a positive electrode that is disposed between the positive electrode current collector and the separator and contains a positive electrode active material, and electrolytic solution, wherein the lithium secondary battery includes a layer containing an anion-absorbing conductive polymer between the positive electrode current collector and the separator.

### CROSS-REFERENCE TO RELATED APPLICATIONS

This application is a continuation of International Application No. PCT/JP2020/037201, filed Sep. 30, 2020, the entire contents of which are incorporated herein by reference.

### BACKGROUND

### Field

The present invention relates to a lithium secondary battery and an anode free battery.

### Description of Related Art

In recent years, techniques for converting natural energy such as solar power or wind power into electric energy have attracted more attention. Accordingly, various secondary batteries have been developed as power storage devices that are highly safe and that can store a large amount of electric energy.

Among these, secondary batteries that charge and discharge by transferring metal ions between a positive electrode and a negative electrode are known to have a high voltage and high energy density, and are typically lithium ion secondary batteries. In a typical lithium ion secondary battery, an active material capable of retaining lithium is introduced into the positive electrode and the negative electrode, and charging and discharging are performed by exchanging lithium ions between the positive electrode active material and the negative electrode active material. A lithium metal secondary battery has also been developed that does not use an active material in the negative electrode, but retains lithium by depositing lithium metal on the surface of the negative electrode.

For example, Patent Document 1 discloses a high-energy-density and high-output lithium-metal anode secondary battery having a volume energy density exceeding 1000 Wh/L and/or a mass energy density exceeding 350 Wh/kg at the time of discharge at at least a rate of 10 at room temperature. Patent Document 1 discloses the use of an ultrathin lithium-metal anode for manufacturing such a lithium-metal anode secondary battery.

Patent Document 2 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.
Patent Document 1: Published Japanese Translation of PCT application No 2019-517722
Patent Document 2: Published Japanese Translation of PCT application No 2019-537226

### SUMMARY

### Technical Problem

As a result of detailed investigation of conventional batteries including those described in the above patent documents, the present inventors have found that at least one of energy density, capacity, and cycle characteristics was insufficient.

For example, a typical secondary battery that charges and discharges by exchanging metal ions between a positive electrode active material and a negative electrode active material does not have sufficient energy density and capacity. Meanwhile, in anode free lithium secondary batteries that retain lithium by depositing lithium metal on the surface of a negative electrode, such as those of the prior art, dendritic lithium metal tends to form on the surface of the negative electrode after repeated charging and discharging, which makes short circuiting and capacity loss more likely to occur. As a result, the cycle characteristics are not sufficient.

With regard to the anode free lithium secondary battery, a method has also been developed of applying a large amount of physical pressure to the battery to keep an interface between the negative electrode and a separator under high pressure, so that discrete growth is suppressed during lithium metal deposition. However, because a large mechanical mechanism is required to apply such a high level of pressure, the weight and volume of the battery increase as a whole, and the energy density decreases.

In view of these problems, it is an object of the present invention to provide a lithium secondary battery and an anode free battery that have high energy density and capacity and have excellent cycle characteristics.

### Solution to Problem

The lithium secondary battery in one embodiment of the present invention includes a positive electrode current collector, a negative electrode that is free of a negative electrode active material, a separator that is disposed between the positive electrode current collector and the negative electrode, a positive electrode that is disposed between the positive electrode current collector and the separator and contains a positive electrode active material, and electrolytic solution, wherein the lithium secondary battery includes a layer containing an anion-absorbing conductive polymer between the positive electrode current collector and the separator.

Because the lithium secondary battery includes a negative electrode that is free of a negative electrode active material, charging and discharging are performed by depositing lithium metal on the surface of the negative electrode and electrolytically dissolving the deposited lithium metal. As a result, energy density is improved.

For the following reasons, the above-described lithium secondary battery has excellent cycle characteristics and has a higher energy density and capacity. In anode free lithium secondary batteries of the prior art, concentration of lithium ions in electrolytic solution tends to increase to improve the cycle characteristics, but because the lithium ions in the electrolytic solution are not consumed for deposition of lithium metal, a high concentration of lithium ions in such electrolytic solution is disadvantageous from the standpoint of increasing energy density. However, in the above-described lithium secondary battery, because the anion-absorbing conductive polymer absorbs anions contained in the electrolytic solution during charging, lithium metal can be deposited on the negative electrode by consuming not only lithium ions derived from the positive electrode but also lithium ions that are counter ions of the anions in the electrolytic solution. Therefore, even in a case where the electrolytic solution containing lithium ions at a high concentration is used, the energy density and the capacity can be increased. Furthermore, because reaction in which the anion-absorbing conductive polymer absorbs the anions contained in the electrolytic solution is more likely to occur as compared with reaction in which the lithium ions are desorbed from the positive electrode, in the above-described lithium secondary battery, a reaction rate of the lithium metal deposition reaction on the negative electrode is slow at an initial stage of charging. As a result, in the above-described lithium secondary battery, the growth of the dendritic lithium metal on the negative electrode is suppressed, and the cycle characteristics are excellent.

The lithium secondary battery in one embodiment of the present invention includes a positive electrode current collector, a negative electrode that is free of a negative electrode active material, a solid electrolyte that is disposed between the positive electrode current collector and the negative electrode, and a positive electrode that is disposed between the positive electrode current collector and the solid electrolyte and contains a positive electrode active material, wherein the lithium secondary battery includes a layer containing an anion-absorbing conductive polymer between the positive electrode current collector and the solid electrolyte.

In the lithium secondary battery including the solid electrolyte as described above, because lithium ions contained in the solid electrolyte are deposited on the negative electrode due to the absorbing of the anions contained in the solid electrolyte to the above-described anion-absorbing conductive polymer, electrolytic solution may not be included. In this aspect of the present invention, because the lithium secondary battery can be a solid-state battery, the lithium secondary battery can be used as a lithium secondary battery with higher safety.

In the above-described lithium secondary battery, a polymer layer containing the anion-absorbing conductive polymer may be disposed between the positive electrode current collector and the positive electrode. In this aspect of the present invention, because the positive electrode current collector and the polymer layer are in direct contact with each other, the absorbing of anions in the anion-absorbing conductive polymer is more likely to occur, and the lithium secondary battery has more improved cycle characteristics.

In the above-described lithium secondary battery, a polymer layer containing the anion-absorbing conductive polymer may be disposed on a surface of the positive electrode, opposite to the positive electrode current collector.

In the above-described lithium secondary battery, the positive electrode may contain the anion-absorbing conductive polymer.

In the above-described lithium secondary battery, an amount of the anion-absorbing conductive polymer in the lithium secondary battery is preferably 1% or more and 15% or less, in terms of capacity ratio, relative to the total capacity of the positive electrode active material and the anion-absorbing conductive polymer. In this aspect of the present invention, balance between the energy density and capacity and the cycle characteristics is further improved.

In the above-described lithium secondary battery, charging and discharging may be performed by depositing lithium metal on the surface of the negative electrode and dissolving the deposited lithium. In this aspect of the present invention, the energy density is further increased.

Preferably, the negative electrode is an electrode consisting of at least one selected from the group consisting of Cu, Ni, Ti, Fe, other metals that do not react with Li, alloys of these metals, and stainless steel (SUS). Because highly flammable lithium metal does not have to be used in this aspect of the present invention during production, safety and productivity are further improved. In addition, because such a negative electrode is stable, the cycle characteristics of the secondary battery are further improved.

Preferably, no lithium foil is formed on the surface of the negative electrode in the lithium secondary battery before initial charging. Because highly flammable lithium metal does not have to be used in this aspect of the present invention during production, safety and productivity are further improved.

The above-described lithium secondary battery preferably has an energy density of 350 Wh/kg or more.

The anode free battery in the embodiment of the present invention includes a positive electrode current collector, a negative electrode a separator that is disposed between the positive electrode current collector and the negative electrode, a positive electrode that is disposed between the positive electrode current collector and the separator and contains a positive electrode active material, and an electrolytic solution, wherein the anode free battery includes a layer containing an anion-absorbing conductive polymer between the positive electrode current collector and the separator.

Because the above-described battery is an anode free battery, the energy density is high. For the following reasons, the above-described anode free battery has excellent cycle characteristics and has a higher energy density and capacity. In anode free batteries of the prior art, concentration of an electrolyte in electrolytic solution tends to increase to improve the cycle characteristics, but because metal ions in the electrolytic solution are not consumed for deposition of metal, a high concentration of the electrolyte in such electrolytic solution is disadvantageous from the standpoint of increasing energy density. However, in the above-described anode free battery, because the anion-absorbing conductive polymer absorbs anions contained in the electrolytic solution during charging, metal can be deposited on the negative electrode by consuming not only metal ions derived from the positive electrode but also metal ions that are counter ions of the anions in the electrolytic solution. Therefore, even in a case where the electrolytic solution containing metal ions at a high concentration is used, the energy density and the capacity can be increased. Furthermore, because reaction in which the anion-absorbing conductive polymer absorbs the anions contained in the electrolytic solution is more likely to occur as compared with reaction in which the metal ions are desorbed from the positive electrode, in the above-described anode free battery, a reaction rate of the metal deposition reaction on the negative electrode is slow at an initial stage of charging. As a result, in the above-described anode free battery, the growth of the dendritic metal on the negative electrode is suppressed, and the cycle characteristics are excellent.

### Effect of Invention

The present invention can provide a lithium secondary battery and an anode free battery, that have high energy density and capacity, and have excellent cycle characteristics.

### BRIEF DESCRIPTION OF DRAWINGS

FIG. 1 is a schematic cross-sectional view of the lithium secondary battery in the first embodiment of the present invention.

FIG. 2 is a schematic cross-sectional view of the lithium secondary battery in the first embodiment of the present invention during use.

FIG. 3 is a schematic cross-sectional view of the lithium secondary battery in the second embodiment of the present invention.

FIG. 4 is a schematic cross-sectional view of the lithium secondary battery in the third embodiment of the present invention.

FIG. 5 is a schematic cross-sectional view of the lithium secondary battery in the fourth embodiment of the present invention.

### DETAILED DESCRIPTION

Embodiments of the present invention (“embodiments”) will now be described with reference to the drawings when necessary. In the drawings, identical elements are designated by the same reference numbers, and redundant descriptions of these elements have been omitted. Positional relationships such as up, down, left, and right are based on the positional relationship shown in the drawings unless otherwise specified. The dimensional ratios shown in the drawings are not limited to the depicted ratios.

### First Embodiment

Lithium Secondary Battery

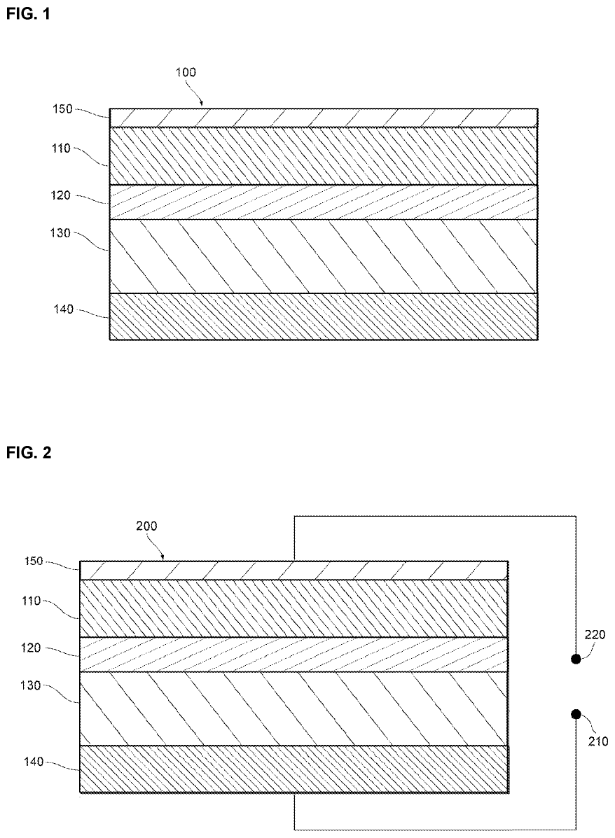

FIG. 1 is a schematic cross-sectional view of the lithium secondary battery in a first embodiment of the present invention. As shown in FIG. 1, the lithium secondary battery 100 in the first embodiment includes a positive electrode 110, a negative electrode 140 that is free of a negative electrode active material, a separator 130 that is disposed between the positive electrode 110 and the negative electrode 140, a polymer layer 120 that is disposed between the positive electrode 110 and the separator 130, and electrolytic solution that is not shown in FIG. 1. A positive electrode current collector 150 is disposed on a side opposite to a surface of the positive electrode 110 facing the polymer layer 120.

Negative Electrode

The negative electrode 140 is free of a negative electrode active material. It is difficult to increase the energy density of a lithium secondary battery with a negative electrode containing a negative electrode active material due to the presence of the negative electrode active material. Because the lithium secondary battery 100 in the present embodiment has the negative electrode 140 that does not contain a negative electrode active material, such a problem does not occur. In other words, the lithium secondary battery 100 in the present embodiment has a high energy density because charging and discharging are performed by depositing lithium metal on the negative electrode 140 and electrolytically dissolving the deposited lithium metal.

In the embodiment, unless otherwise specified, the “lithium metal is deposited on the negative electrode” means the lithium metal is deposited on at least one of the surface of the negative electrode and the surface of a solid electrolyte interphase layer (SEI layer) formed on the surface of the negative electrode, which will be described later. Therefore, in the lithium secondary battery 100, for example, the lithium metal may be deposited on the surface of the negative electrode 140 (interface between the negative electrode 140 and the separator 130).

In the present specification, unless otherwise specified, the “negative electrode active material” refers to a material for retaining lithium ions or lithium metal on the negative electrode 140, and may also be referred to as a host material for a lithium element (typically, lithium metal). Examples of retaining mechanisms include, but are not limited to, intercalation, alloying, and occlusion of metallic clusters, and intercalation is typically used.

Examples of such a negative electrode active material include, but are not limited to, carbon-based substances, metal oxides, metals alloyed with lithium, and alloys containing the metals. Carbon-based substances include, but are not limited to, graphene, graphite, hard carbon, mesoporous carbon, carbon nanotubes, and carbon nanohorns. Examples of metal oxides include, but are not limited to, titanium oxide-based compounds, tin oxide-based compounds, and cobalt oxide-based compounds. Examples of metals alloyed with lithium include silicon, germanium, tin, lead, aluminum, and gallium.

There are no particular restrictions on the negative electrode 140 as long as it does not contain a negative electrode active material and can be used as a current collector. Examples of the negative electrode 140 include electrodes consisting of at least one selected from the group consisting of Cu, Ni, Ti, Fe and other metals that do not react with Li, alloys of these metals, and stainless steel (SUS). When SUS is used as the negative electrode 140, any well-known type of SUS can be used. The negative electrode materials mentioned above may be used alone or in combinations of two or more. In the present specification, the “metal that does not react with Li” refers to a metal that does not react with lithium ions or lithium metal to form an alloy under the operating conditions of the lithium secondary battery.

The negative electrode 140 is preferably a lithium-free electrode. Because highly flammable lithium metal does not have to be used in the production process, the lithium secondary battery 100 with even better safety and productivity can be realized. From this standpoint and from the standpoint of improving the stability of the negative electrode 140, the negative electrode 140 preferably consists of at least one selected from the group consisting of Cu, Ni, alloys of these metals, and stainless steel (SUS). From the same standpoints, the negative electrode 140 more preferably consists of Cu, Ni, or alloys of these metals, and even more preferably of Cu or Ni.

In the present specification, a “negative electrode free of a negative electrode active material” means the amount of the negative electrode active material in the negative electrode is 10% by mass or less relative to the overall mass of the negative electrode. The amount of negative electrode active material in the negative electrode relative to the overall mass of the negative electrode is preferably 5.0% by mass or less relative to the overall mass of the negative electrode, and may be 1.0% by mass or less, 0.1% by mass or less, or 0.0% by mass or less. The lithium secondary battery 100 has a negative electrode that is free of a negative electrode active material means that it is an anode free secondary battery, a zero anode secondary battery, or an anodeless secondary battery in the general sense of the terms.

The capacity of the negative electrode 140 may be sufficiently smaller than the capacity of the positive electrode 110, and may be, for example, 20% or less, 15% or less, 10% or less, or 5% or less. Therefore, the negative electrode 140 can be rephrased as a negative electrode current collector. The capacities of the positive electrode 110 and the negative electrode 140 can be measured by any method common in the art, respectively.

The average thickness of the negative electrode 140 is preferably 4 μm or more and 20 μm or less, more preferably 5 μm or more and 18 μm or less, and even more preferably 6 μm or more and 15 μm or less. Because the volume occupied by the negative electrode 140 in the lithium secondary battery 100 is reduced in this aspect of the present invention, the energy density of the lithium secondary battery 100 is further improved.

Positive Electrode

Positive electrode 110 is not particularly limited as long as it has a positive electrode active material and is a positive electrode commonly used in a lithium secondary battery and a known material can be selected as needed, depending on the use of the lithium secondary battery. Because the positive electrode 110 has a positive electrode active material, the stability and the output voltage are high.

In the present specification, the “positive electrode active material” means a material used to retain a lithium element (typically, lithium ions) in the positive electrode 110, and may be referred to as a host material for the lithium element (typically, lithium ions).

Examples of positive electrode active materials include, but are not limited to, metal oxides and metal phosphates. Examples of metal oxides include, but are not limited to, cobalt oxide-based compounds, manganese oxide-based compounds, and nickel oxide-based compounds. Examples of metal phosphates include, but are not limited to, iron phosphate-based compounds and cobalt phosphate-based compounds. Typical examples of positive electrode active materials include LiCoO₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. The positive electrode active materials mentioned above can be used alone or in combinations of two or more.

The positive electrode 110 may contain components other than the positive electrode active material. Examples of these components include, but are not limited to, commonly used conductive aids, binders, solid polymer electrolytes, and inorganic solid electrolytes.

Examples of conductive aids that can be used in the positive electrode 110 include, but are not limited to, carbon black, single-wall carbon nanotubes (SWCNT), multi-wall carbon nanotubes (MWCNT), carbon nanofibers (CF), and acetylene black. Examples of binders include, but are not limited to, polyvinylidene fluoride, polytetrafluoroethylene, styrene butadiene rubber, acrylic resins, and polyimide resins.

The amount of the positive electrode active material in the positive electrode 110 may be, for example, 50% by mass or more and 100% by mass or less relative to the overall mass of the positive electrode 110. The amount of the conductive aid in the positive electrode 110 may be, for example, 0.5% by mass or more and 30% by mass or less relative to the overall mass of the positive electrode 110. The amount of the binder in the positive electrode 110 may be, for example, 0.5% by mass or more and 30% by mass or less relative to the overall mass of the positive electrode 110. The total amount of the solid polymer electrolyte and the inorganic solid electrolyte may be 0.5% by mass or more and 30% by mass or less relative to the overall mass of the positive electrode 110.

Positive Electrode Current Collector

The positive electrode current collector 150 is disposed on one side of the positive electrode 110. The positive electrode current collector 150 is not particularly limited as long as it is a conductor that does not react with lithium ions in the battery. Examples of such a positive electrode current collector include aluminum.

The average thickness of the positive electrode current collector 150 is preferably 4 μm or more and 20 μm or less, more preferably 5 μm or more and 18 μm or less, and even more preferably 6 μm or more and 15 μm or less. In this aspect of the present invention, because the volume occupied by the positive electrode current collector 150 in the lithium secondary battery 100 is reduced, the energy density of the lithium secondary battery 100 is further improved.

Separator

The separator 130 is the component that separates the positive electrode 110 and the negative electrode 140 to prevent short circuiting of the battery, while maintaining conductivity of the lithium ions serving as the charge carrier between the positive electrode 110 and the negative electrode 140. The separator 130 consists of a material that does not have electronic conductivity and that does not react with lithium ions. The separator 130 also plays a role in retaining the electrolytic solution. There are no particular restrictions on the separator 130 as long as it can play this role. The separator 130 can be composed of, for example, a porous polyethylene (PE) film, a polypropylene (PP) film, or a laminated structure thereof.

The separator 130 may be coated with a separator coating layer. The separator coating layer can be applied to one or both sides of the separator 130. The separator coating layer is not particularly limited as long as it has ionic conductivity and does not react with lithium ions. The separator coating layer preferably bonds the separator 130 to the adjacent layer firmly. Examples of such a separator coating layer include, but are not limited to, a layer containing a binder such as polyvinylidene fluoride (PVDF), styrene butadiene rubber and carboxymethyl cellulose (SBR-CMC) mixtures, polyacrylic acid (PAA), lithium polyacrylate (Li-PAA), polyimide (PI), polyamideimide (PAI), and aramids. The separator coating layer may contain inorganic particles such as silica, alumina, titania, zirconia, magnesium oxide, magnesium hydroxide, and lithium nitrate in the above-described binder. The separator 130 includes a separator having a separator coating layer.

The average thickness of the separator 130 is preferably 30 μm or less, more preferably 25 μm or less, and even more preferably 20 μm or less. Because the volume occupied by the separator 130 in the lithium secondary battery 100 is reduced in this aspect of the present invention, the energy density of the lithium secondary battery 100 is further improved. The average thickness of the separator 130 is also preferably 5 μm or more, more preferably 7 μm or more, and even more preferably 10 μm or more. In this aspect of the present invention, the positive electrode 110 and the negative electrode 140 can be separated more reliably, and short circuiting of the battery can be further suppressed.

Polymer Layer

The polymer layer 120 is a layer containing an anion-absorbing conductive polymer, and is preferably a layer consisting of the anion-absorbing conductive polymer. The polymer layer 120 is disposed between the separator 130 and the positive electrode 110, and may be formed on the separator 130 side or the positive electrode 110 side. The lithium secondary battery 100 is preferably configured such that the polymer layer 120 is in contact with the positive electrode 110. In a case where the polymer layer 120 is not configured to be in contact with the positive electrode 110, when the lithium secondary battery is used, pressure may be applied in a thickness direction of the battery so that the polymer layer 120 is in contact with the positive electrode 110.

In the present specification, the “anion-absorbing conductive polymer” means a polymer that absorbs or can absorb anions during battery charging, and that has conductivity or exhibits conductivity by the absorbing of the anions. Because the polymer layer 120 has such an anion-absorbing conductive polymer, the polymer layer 120 absorbs the anions contained in the electrolytic solution when the lithium secondary battery 100 is charged, and supplies electrons to the negative electrode 140 via the positive electrode 110 and the positive electrode current collector 150. Here, in the lithium secondary battery 100 as a whole, in order to maintain electrical neutrality in the electrolytic solution, lithium ions that are counter ions of the absorbed anions are reduced on the negative electrode 140, and lithium metal is deposited on the negative electrode. Because the deposition of lithium metal on the negative electrode due to the absorbing of such anions is more likely to occur (the deposition occurs in lower voltage conditions) as compared with deposition of lithium metal on the negative electrode due to desorption of lithium ions from the positive electrode active material, in the lithium secondary battery 100, the reaction rate of the lithium metal deposition reaction on the negative electrode is slow at the initial stage of charging. As a result, in the lithium secondary battery 100, the growth of the dendritic lithium metal on the negative electrode is suppressed, and the cycle characteristics are excellent. However, the factors that cause the lithium secondary battery 100 to have excellent cycle characteristics are not limited to the above.

As described above, in the lithium secondary battery 100, because, during charging, especially at the initial stage of charging, the lithium ions in the electrolytic solution are consumed and lithium metal is deposited on the negative electrode, the energy density and capacity are high for the following reason. That is, in anode free lithium secondary batteries of the prior art, concentration of lithium ions in electrolytic solution tends to increase to improve the cycle characteristics, but because the lithium ions in the electrolytic solution are not consumed for deposition of lithium metal, a high concentration of such lithium ions is disadvantageous from the standpoint of increasing energy density. On the other hand, in the lithium secondary battery 100 in which lithium metal in the electrolytic solution can be consumed and deposited on the negative electrode, because lithium ions in the electrolytic solution can be used as a lithium source, a high concentration of lithium ions in the electrolytic solution is not disadvantageous from the standpoint of energy density, and both excellent cycle characteristics and high energy density and capacity can be achieved. However, the factors that both excellent cycle characteristics and high energy density and capacity can be achieved in the lithium secondary battery 100 are not limited to the above.

The “initial stage of charging” means a charging stage in a situation in which a charging rate (state of charge (SOC)) of the battery is low, and for example, the “initial stage of charging” refers to a charge stage at a charging rate of 40% or less, 25% or less, or 10% or less. However, the above-described specific numerical value also depends on the amount of the anion-absorbing conductive polymer. The charging rate of the battery can be estimated by measuring an open circuit voltage of the battery.

The anion-absorbing conductive polymer is not particularly limited as long as it is a polymer that absorbs or can absorb anions during battery charging, and that has conductivity or exhibits conductivity by the absorbing of the anions. From the standpoint of further improving the cycle characteristics of the lithium secondary battery 100, the anion-absorbing conductive polymer undergoes anion doping, that is, can absorb anions at a potential of preferably 3.0 V or less, more preferably 2.5 V or less, still more preferably 2.0 V or less relative to the lithium counter electrode.

Examples of anion-absorbing conductive polymers include polymers having a conjugate system in the polymer main chain. In such a polymer, when a predetermined potential is applied to the electrolytic solution, the polymer is doped with the anions in the electrolytic solution to exhibit conductivity, that is, the polymer absorbs the anions and develops conductivity due to the absorbing of the anions. Examples of the anion-absorbing conductive polymer include, but are not limited to, polyacetylene, polyaniline, polypyrrole, polythiophene, polyethylenedioxythiophene, poly-p-phenylene, polyfluorene, poly-p-phenylenevinylene, polythienylenevinylene, and derivatives of these compounds (limited to those having a conjugate system in the polymer main chain). These polymers can be used alone or in combinations of two or more.

The polymer layer 120 may contain a component other than the anion-absorbing conductive polymer. Examples of the component other than the anion-absorbing conductive polymer include polymers other than the anion-absorbing conductive polymer, inorganic particles that can be contained in the separator coating layer, known conductive aids, binders, solid polymer electrolytes, and inorganic solid electrolytes that can be contained in the positive electrode 110.

The thickness of the polymer layer 120 is not particularly limited, but is preferably 100 nm or more and 50 μm or less, more preferably 500 nm or more and 10 μm or less, and even more preferably 1.0 μm or more and 5.0 μm or less. When the thickness of the polymer layer is within the above-described range, the balance between the energy density and capacity and the cycle characteristics of the lithium secondary battery 100 can be improved.

In the lithium secondary battery 100, the amount of the anion-absorbing conductive polymer is preferably 1% or more and 15% or less, and more preferably 5% or more and 10% or less, in terms of capacity ratio, relative to the total capacity of the positive electrode active material and the anion-absorbing conductive polymer. Each capacity of the positive electrode active material and the anion-absorbing conductive polymer can be measured by any method common in the art.

Electrolytic Solution

In the lithium secondary battery 100, the electrolytic solution may be impregnated in the separator 130, or may be sealed together with a laminate of the positive electrode 110, the polymer layer 120, the separator 130, and the negative electrode 140 inside a sealed container. The electrolytic solution is solution that contains an electrolyte and a solvent and has ionic conductivity, and acts as a conductive path for lithium ions. Therefore, in the lithium secondary battery 100, an internal resistance of the battery is further reduced, and the energy density, capacity, and cycle characteristics are further improved.

The electrolyte in the electrolytic solution may contain a lithium salt, but may contain other salts such as Na, K, Ca, and Mg salts. The anions of the electrolyte are not particularly limited, and examples of the anions include I⁻, Cl⁻, Br⁻, F⁻, ClO₄⁻, BF₄⁻, PF₆⁻, AsF₆⁻, SO₃CF₃⁻, N(SO₂F)₂⁻, N(SO₂CF₃)₂⁻, N(SO₂CF₃CF₃)₂⁻, B(O₂C₂H₄)₂⁻, B(O₂C₂H₄)F₂⁻, B(OCOCF₃)₄⁻, NO₃⁻, and SO₄²⁻. From the standpoint of enhancing the interaction between the anion-absorbing conductive polymer and the anions, the anions of the electrolyte is preferably ClO₄, BF₄⁻, PF₆⁻, AsF₆⁻, or N(SO₂F)₂⁻, and more preferably BF₄⁻, PF₆⁻, or N(SO₂F)₂⁻.

Examples of lithium salts that can be used include, but are not limited to, LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₁₄)₂, LiB(O₂C₂H₄)F₂, LiB(OCOCF₃)₄, LiNO₃, and Li₂SO₄. From the standpoint of further improving the energy density, capacity, and cycle characteristics of the lithium secondary battery 100, use of LiN(SO₂F)₂ as the lithium salt is preferred. These lithium salts can be used alone or in combinations of two or more.

The solvent is not particularly limited, and examples of the solvent include dimethoxyethane, dimethyl ether, diethylene glycol dimethyl ether, triethylene glycol dimethyl ether, acetonitrile, dimethyl carbonate, diethyl carbonate, ethyl methyl carbonate, ethylene carbonate, propylene carbonate, chloroethylene carbonate, fluoroethylene carbonate, difluoroethylene carbonate, trifluoromethyl propylene carbonate, methyl acetate, ethyl acetate, propyl acetate, methyl propionate, ethyl propionate, nonafluorobutyl methyl ether, nonafluorobutyl ethyl ether, tetrafluoroethyltetrafluoropropyl ether, 1,1,2,2-tetrafluoroethyl-2,2,3,3-tetrafluoropropyl ether, 1,1,2,2-tetrafluoroethyl-2,2,2-trifluoroethyl ether, trimethyl phosphate, and triethyl phosphate. These solvents may be used alone or in combinations of two or more.

The concentration of the electrolyte in the electrolytic solution is not particularly limited, but is preferably 0.5 M or more, more preferably 0.7 M or more, even more preferably 0.9 M or more, and still more preferably 1.1 M or more. When the concentration of the electrolyte is within the above-described range, the lithium secondary battery 100 can achieve both more excellent cycle characteristics and higher energy density and capacity. The upper limit of the concentration of the electrolyte is not particularly limited, and the concentration of the electrolyte may be 10.0 M or less, 5.0 M or less, or 2.0 M or less.

Use of Lithium Secondary Battery

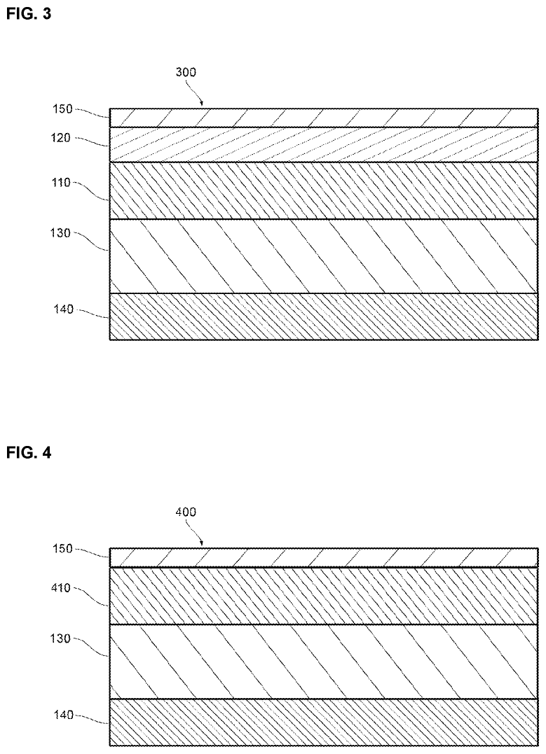

FIG. 2 illustrates one use aspect of the lithium secondary battery in the embodiment. As the lithium secondary battery 200, a positive electrode terminal 220 and a negative electrode terminal 210 for connecting the lithium secondary battery to an external circuit are connected to the positive electrode current collector 150 and the negative electrode 140 in the lithium secondary battery 100, respectively. The lithium secondary battery 200 is charged and discharged by connecting the negative electrode terminal 210 to one end of the external circuit and connecting the positive electrode terminal 220 to the other end of the external circuit.

The lithium secondary battery 200 is charged by applying voltage between the positive electrode terminal 220 and the negative electrode terminal 210 so that current flows from the negative electrode terminal 210 to the positive electrode terminal 220 via the external circuit. By charging the lithium secondary battery 200, the lithium metal is deposited on the negative electrode. In the lithium secondary battery 200, during charging, especially at the initial stage of charging, the anion-absorbing conductive polymer of the polymer layer 120 absorbs the anions in the electrolytic solution, resulting in deposition of lithium metal on the negative electrode.

In the lithium secondary battery 200, the solid electrolyte interphase layer (SEI layer) may be formed on the surface of the negative electrode 140 (interface between the negative electrode 140 and the separator 130) by a first charging (“initial charging”) after the battery is assembled. There are no particular restrictions on the SEI layer that is formed, but it may contain, for example, a lithium-containing inorganic compound and a lithium-containing organic compound. The typical average thickness of the SEI layer is 1 nm or more and 10 μm or less.

When the positive electrode terminal 220 and the negative electrode terminal 210 in the charged lithium secondary battery 200 are connected, the lithium secondary battery 200 is discharged. As a result, the deposition of the lithium metal generated on the negative electrode is electrolytically dissolved. In addition, the anions are released from the anion-absorbing conductive polymer.

Lithium Secondary Battery Production Method

There are no particular restrictions on the method used to produce the lithium secondary battery 100 shown in FIG. 1 as long as it can produce a lithium secondary battery with the configuration described above. The following method is an example.

First, the positive electrode 110 is prepared by a known production method or by purchasing a commercially available one. The positive electrode 110 may be produced in the following manner. Such a positive electrode active material as mentioned above, a known conductive aid, and a known binder are mixed together to obtain a positive electrode mixture. The mixing ratio may be, for example, 50% by mass or more and 99% by mass or less of the positive electrode active material, 0.5% by mass or more and 30% by mass or less of the conductive aid, and 0.5% by mass or more and 30% by mass or less of the binder relative to the entire mass of the positive electrode mixture. The resulting positive electrode mixture is applied to one surface of a metal foil (for example, Al foil) as a positive electrode current collector, that has a predetermined thickness (for example, 5 μm or more and 1 mm or less), and then press-molded. The resulting molded material is punched to a predetermined size to obtain a positive electrode 110 formed on a positive electrode current collector 150.

Next, a negative electrode material, such as metal foil (such as electrolytic Cu foil) with a thickness of 1 μm or more and 1 mm or less, is washed with a solvent containing sulfamic acid, punched out to a predetermined size, washed again ultrasonically with ethanol, and then dried to obtain the negative electrode 140.

Next, the separator 130 with the configuration described above is prepared. The separator 130 may be produced using any method common in the art, or a commercially available one may be used.

The polymer layer 120 may be formed on one surface of the separator 130 (surface facing the positive electrode 110) or one surface of the positive electrode 110 (surface facing the separator 130). The polymer layer 120 can be obtained by applying a solution that is obtained by dissolving the above-described anion-absorbing conductive polymer in a solvent such as m-cresol, water, or xylene, to one surface of the separator 130 or the positive electrode 110 by a method such as a dip coating method or a spin coating method, and then removing the solvent by drying. As the method for applying the polymer solution, a method using an apparatus such as a comma coater, a gravure coater, and a die coater can also be used. The solution containing the above-described anion-absorbing conductive polymer may contain polymers other than the anion-absorbing conductive polymer, inorganic particles that can be contained in the separator coating layer, known conductive aids, binders, solid polymer electrolytes, and inorganic solid electrolytes that can be contained in the positive electrode 110.

The electrolytic solution may be prepared by dissolving the above-described electrolyte (typically, a lithium salt) in the above-described solvent.

The positive electrode current collector 150 on which the positive electrode 110 is formed, the separator 130, and the negative electrode 140 described above are laminated in this order to obtain a laminate as shown in FIG. 1. As described above, the polymer layer 120 is formed on one surface of the separator 130 or the positive electrode 110. The resulting laminate is then sealed in a sealed container together with the electrolytic solution to obtain the lithium secondary battery 100. There are no particular restrictions on the sealed container. Examples of the sealed container include a laminated film.

### Second Embodiment

Lithium Secondary Battery

FIG. 3 is a schematic cross-sectional view of the lithium secondary battery in a second embodiment of the present invention. As shown in FIG. 3, the lithium secondary battery 300 in the second embodiment includes a positive electrode current collector 150, a polymer layer 120 that is formed on the positive electrode current collector 150, a positive electrode 110 that is disposed on a side of the polymer layer 120 opposite to the positive electrode current collector 150, a negative electrode 140 that is free of a negative electrode active material, a separator 130 that is disposed between the positive electrode 110 and the negative electrode 140, and electrolytic solution that is not shown in FIG. 3.

The configuration and preferred aspects of the electrolytic solution, the positive electrode 110, the polymer layer 120, the separator 130, the negative electrode 140, and the positive electrode current collector 150 are the same as those of the lithium secondary battery 100 in the first embodiment. This lithium secondary battery 300 has the same effects as the lithium secondary battery 100 described above.

In the lithium secondary battery 300, because the positive electrode current collector 150 and the polymer layer 120 are in direct contact with each other, anion doping of the anion-absorbing conductive polymer, that is, absorbing of anions is more likely to occur, and it is considered that the lithium secondary battery 300 has more excellent cycle characteristics than the lithium secondary battery 100.

The lithium secondary battery 300 can be produced by a method same as the method for producing the lithium secondary battery 100 in the first embodiment, except that the polymer layer 120 is formed on one surface of the positive electrode current collector 150 by the same method as the method for forming the polymer layer 120 in the first embodiment, and the positive electrode 110 is further formed on the surface of the polymer layer 120 opposite to the positive electrode current collector 150 by the same method as the method for forming the positive electrode 110 in the first embodiment.

### Third Embodiment

Lithium Secondary Battery

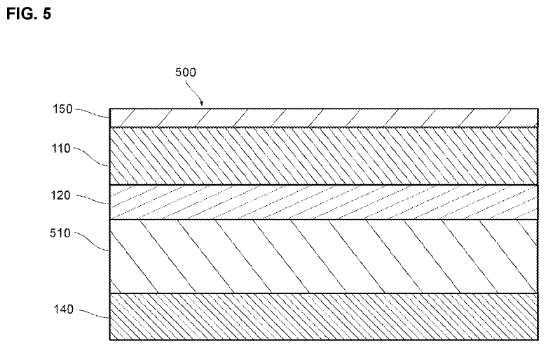

FIG. 4 is a schematic cross-sectional view of the lithium secondary battery in a third embodiment of the present invention. As shown in FIG. 4, the lithium secondary battery 400 in the third embodiment includes a positive electrode 410, a negative electrode 140 that is free of a negative electrode active material, a separator 130 that is disposed between the positive electrode 410 and the negative electrode 140, and electrolytic solution that is not shown in FIG. 4. A positive electrode current collector 150 is disposed on a side opposite to a surface of the positive electrode 410 facing the separator 130.

The configuration and preferred aspects of the electrolytic solution, the separator 130, the negative electrode 140, and the positive electrode current collector 150 are the same as those of the lithium secondary battery 100 in the first embodiment.

The positive electrode 410 contains an anion-absorbing conductive polymer in addition to the positive electrode active material. That is, the positive electrode 410 is obtained by adding an anion-absorbing conductive polymer to the positive electrode 110 in the lithium secondary battery 100 in the first embodiment. In this aspect of the present invention, the lithium secondary battery 400 not only has the same effects as those of the lithium secondary battery 100, but also can be produced more simply, so that a battery having excellent productivity can be obtained.

The types, examples, preferred aspects, and amounts of the positive electrode active material contained in the positive electrode 410 and components other than the positive electrode active material, that may be contained in the positive electrode 410 (specifically, conductive aid, binder, solid polymer electrolyte, and inorganic solid electrolyte) are the same as those in the positive electrode 110.

The definition, examples, and preferred aspects of the anion-absorbing conductive polymer contained in the positive electrode 410 are the same as those of the polymer layer 120 in the lithium secondary battery 100 in the first embodiment. In the positive electrode 410, the amount of the anion-absorbing conductive polymer is adjusted to be preferably 1% or more and 15% or less, and more preferably 5% or more and 10% or less, in terms of capacity ratio, relative to the total capacity of the positive electrode active material and the anion-absorbing conductive polymer. The amount of the anion-absorbing conductive polymer may be 1% by mass or more and 25% by mass or less, 3% by mass or more and 20% by mass or less, or 5% by mass or more and 15% by mass or less in terms of mass ratio relative to the overall mass of the positive electrode 410.

The lithium secondary battery 400 can be produced by the same method as that of the lithium secondary battery 100, except that, during formation of the positive electrode 110, the anion-absorbing conductive polymer is added in addition to the positive electrode active material, and the polymer layer 120 is not formed. In the method for producing the lithium secondary battery 400, as compared with the method for producing the lithium secondary battery 100, because the step of forming the polymer layer 120 can be omitted, the lithium secondary battery can be efficiently produced.

### Fourth Embodiment

Lithium Secondary Battery

FIG. 5 is a schematic cross-sectional view of the lithium secondary battery in a fourth embodiment of the present invention. As shown in FIG. 5, the lithium secondary battery 500 in the fourth embodiment includes a positive electrode 110, a negative electrode 140 that is free of a negative electrode active material, a solid electrolyte 510 that is disposed between the positive electrode 110 and the negative electrode 140, and a polymer layer 120 that is disposed between the positive electrode 110 and the solid electrolyte 510. A positive electrode current collector 150 is disposed on a side opposite to a surface of the positive electrode 110 facing the polymer layer 120.

The configuration and preferred aspects of the positive electrode 110, the polymer layer 120, the negative electrode 140, and the positive electrode current collector 150 are the same as those of the lithium secondary battery 100 in the first embodiment. This lithium secondary battery 500 has the same effects as the lithium secondary battery 100 described above. The lithium secondary battery 500 may include an electrolytic solution as included in the lithium secondary battery 100.

Solid Electrolyte

In general, in a battery containing liquid electrolyte, the physical pressure applied by the electrolyte to the surface of the negative electrode tends to vary locally due to fluctuations in the liquid. However, because the lithium secondary battery 500 includes the solid electrolyte 510, the pressure applied to the surface of the negative electrode 140 from the solid electrolyte 510 is uniform, and the shape of the lithium metal deposited on the surface of the negative electrode 140 is more uniform. Because the lithium metal deposited on the surface of the negative electrode 140 in this aspect of the present invention is kept from growing in the form of dendrites, the cycle characteristics of the lithium secondary battery 500 are further improved.

The solid electrolyte 510 is not particularly limited as long as it is a solid electrolyte commonly used in a solid-state lithium secondary battery and a known material can be selected as needed, depending on the use of the lithium secondary battery 500. Preferably, the solid electrolyte 510 has ionic conductivity and no electronic conductivity. When the solid electrolyte 510 has ionic conductivity and no electronic conductivity, the internal resistance in the lithium secondary battery 500 is further reduced and short circuiting inside the lithium secondary battery 500 is further suppressed. As a result, the lithium secondary battery 500 has a higher energy density and capacity and even more excellent cycle characteristics.

There are no particular restrictions on the solid electrolyte 510. Examples of the solid electrolyte 510 include, for example, a solid electrolyte including resins and lithium salts. Examples of the resins include, but are not limited to, resins having an ethylene oxide unit in a main chain and/or a side chain, acrylic resins, vinyl resins, ester resins, nylon resins, polysiloxanes, polyphosphazene, polyvinylidene fluoride, polymethyl methacrylate, polyamides, polyimides, aramids, polylactic acid, polyethylenes, polystyrenes, polyurethanes, polypropylenes, polybutylenes, polyacetals, polysulfones, and polytetrafluoroethylene. These resins can be used alone or in combinations of two or more.

The lithium salt contained in the solid electrolyte 510 is not particularly limited, and examples of the lithium salt include salts as lithium salts that can be contained in the electrolytic solution of the lithium secondary battery 100 mentioned above. These lithium salts may be used alone or in combinations of two or more.

Generally, the ratio of resin to lithium salt in the solid electrolyte is determined by the ratio of oxygen atoms in the resin to lithium atoms in the lithium salt ([Li]/[O]). In the solid electrolyte 510 of the present embodiment, the ratio of resin to lithium salt in terms of the ([Li]/[O]) ratio is preferably 0.02 or more and 0.20 or less, more preferably 0.03 or more and 0.15 or less, and even more preferably 0.04 or more and 0.12 or less.

The solid electrolyte 510 may contain components other than the resins and lithium salts mentioned above. Examples of the components include, but are not limited to, solvents and salts other than lithium salts. Examples of the salts other than lithium salts include, but are not limited to, Na, K, Ca, and Mg salts. There are no particular restrictions on the solvent. Examples of the solvent include the solvents that can be contained in the electrolytic solution of the lithium secondary battery 100 mentioned above. These solvents and salts other than lithium salt may be used alone or in combinations of two or more.

The average thickness of solid electrolyte 510 is preferably 20 μm or less, more preferably 18 μm or less, and even more preferably 15 μm or less. In this aspect of the present invention, because the volume occupied by the solid electrolyte 510 in the lithium secondary battery 500 is reduced, the energy density of the lithium secondary battery 500 is further improved. The average thickness of solid electrolyte 510 is also preferably 5 μm or more, more preferably 7 μm or more, and even more preferably 10 μm or more. In this aspect of the present invention, the positive electrode 110 and the negative electrode 140 can be separated more reliably, and short circuiting of the battery can be further suppressed.

The solid electrolyte 510 embraces a gel electrolyte. Examples of the gel electrolytes include, but are not limited to, those containing polymers, organic solvents, and lithium salts. Examples of the polymers that can be used in the gel electrolyte include, but are not limited to, copolymers of polyethylene and/or polyethylene oxide, polyvinylidene fluoride, and copolymers of polyvinylidene fluoride and hexafluoropropylene.

Secondary Battery Production Method

The lithium secondary battery 500 can be produced in the same manner as the method for producing a lithium secondary battery 100 of the first embodiment described above, except that the solid electrolyte is used instead of the separator.

There are no particular restrictions on the method used to produce the solid electrolyte 510, as long as the method produces the solid electrolyte 510 described above. A resin and lithium salt commonly used in a solid electrolyte (such as the resins and lithium salts in the solid electrolyte 510 described above) are dissolved in an organic solvent (for example, N-methylpyrrolidone and acetonitrile). The resulting solution is then cast on a molding substrate to a predetermined thickness to obtain the solid electrolyte 510. Here, the mixing ratio of the resin and the lithium salt may be determined based on the ratio ([Li]/[O]) of the oxygen atoms in the resin and the lithium atoms in the lithium salt, as described above. This ratio ([1i]/[0]) may be, for example, 0.02 or more and 0.20 or less. There are no particular restrictions on the molding substrate that is used, which may be, for example, a PET film or a glass substrate.

### Modification Example

The embodiments described above are provided merely to explain the present invention and are not intended to limit the present invention to the embodiments. Various modifications are possible without departing from the scope and spirit of the present invention.

For example, in the lithium secondary battery 100 in the first embodiment, separators 130 may be formed on both surfaces of the negative electrode 140. In this case, in the lithium secondary battery, each component is laminated in the following order: positive electrode current collector/positive electrode/polymer layer/separator/negative electrode/separator/polymer layer/positive electrode/positive electrode current collector. In this aspect of the present invention, the capacity of the lithium secondary battery can be further improved.

The lithium secondary battery 500 may be a solid-state lithium secondary battery. Because it is not necessary to use electrolytic solution in this aspect of the present invention, the problem of electrolytic solution leakage does not occur, and the safety of the battery is further improved.

In the lithium secondary batteries, the anion-absorbing conductive polymer may be contained in a layer disposed between the positive electrode current collector and the separator, and the layer containing the anion-absorbing conductive polymer is not limited to the polymer layer and positive electrode described above, and may be in any form. In addition, two layers of the polymer layer containing the anion-absorbing conductive polymer may be included in a form of being separated and arranged between the positive electrode current collector and the positive electrode and between the positive electrode and the separator.

In the lithium secondary battery 100 and the lithium secondary battery 300, the positive electrode 110 may contain the anion-absorbing conductive polymer. That is, the lithium secondary batteries may include the polymer layer containing the anion-absorbing conductive polymer and the positive electrode containing the anion-absorbing conductive polymer.

In the lithium secondary battery 500, the polymer layer 120 may be disposed between the positive electrode current collector 150 and the positive electrode 110, and the positive electrode 110 may contain the anion-absorbing conductive polymer.

In a case where the anion-absorbing conductive polymer is divided into and contained in two or more layers in the lithium secondary battery, the total amount of the anion-absorbing conductive polymer is adjusted to be preferably 1% or more and 15% or less, and more preferably 5% or more and 10% or less, in terms of capacity ratio, relative to the total capacity of the positive electrode active material and the anion-absorbing conductive polymer.

In the lithium secondary batteries, an auxiliary member that assists the deposition and/or dissolution of lithium metal between the separator and the negative electrode during charging and discharging may be provided. Examples of such an auxiliary member include members containing a metal that is alloyed with the lithium metal, and may be, for example, a metal layer formed on the surface of the negative electrode. Examples of such a metal layer include layers containing at least one selected from the group consisting of Si, Sn, Zn, Bi, Ag, In, Pb, Sb, and Al. The average thickness of the metal layer may be, for example, 5 nm or more and 500 nm or less.

In this aspect of including the above-described auxiliary member in the lithium secondary battery 100, because affinity between the negative electrode and the lithium metal deposited on the negative electrode is further improved, peeling of the lithium metal deposited on the negative electrode is further suppressed, and the cycle characteristics tend to be further improved. The auxiliary member may contain the metal that is alloyed with the lithium metal, but the capacity thereof is sufficiently smaller than the capacity of the positive electrode. In a typical lithium ion secondary battery, the capacity of the negative electrode active material contained in the negative electrode is set to be about the same as the capacity of the positive electrode, but because the capacity of the auxiliary member is sufficiently smaller than the capacity of the positive electrode, the lithium secondary battery 100 including such an auxiliary member can be said to “include a negative electrode that is free of a negative electrode active material”. Therefore, the capacity of the auxiliary member may be sufficiently smaller than the capacity of the positive electrode, and may be, for example, 20% or less, 15% or less, 10% or less, or 5% or less.

In the lithium secondary batteries described in the embodiments, there may be no lithium foil to be formed between the separator or the solid electrolyte and the negative electrode prior to the initial charging. When lithium foil is not formed between the separator or solid electrolyte and the negative electrode in the lithium secondary battery of the embodiments before the initial charging, highly flammable lithium metal is not used during production, and the lithium secondary battery with better safety and higher productivity is realized.

In the lithium secondary batteries described in the embodiments, a current collector may or may not be provided on the surface of the negative electrode disposed so as to be in contact with the negative electrode. Examples of such a current collector include, but are not limited to, those that can be used for the negative electrode material. In a case where the lithium secondary battery does not include a negative electrode current collector, the negative electrode itself acts as the current collector.

In the lithium secondary batteries described in the embodiments, a terminal for connecting to an external circuit may be attached to the positive electrode current collector and/or the negative electrode. For example, a metal terminal (for example, Al, Ni, and the like) of 10 μm or more and 1 mm or less may be connected to one or both of the positive electrode current collector and the negative electrode. As the connecting method, any method common in the art may be used, and for example, ultrasonic welding may be used.

In the present specification, “the energy density is high” and “high energy density” mean the capacity is high relative to the total volume or total mass of the battery. This is preferably 800 Wh/L or more or 350 Wh/kg or more, more preferably 900 Wh/L or more or 400 Wh/kg or more, and even more preferably 1000 Wh/L or more or 450 Wh/kg or more.

In the present specification, “excellent cycle characteristics” means that the rate of decline in battery capacity is low before and after the number of times of charging and discharging cycles that can be expected during normal use. In other words, when comparing a first discharge capacity after initial charging to a discharge capacity after the number of times of charging and discharging cycles that can be expected during normal use, the discharge capacity after the charging and discharging cycles has not declined significantly relative to the first discharge capacity after the initial charging. Here, “the number of times that can be expected during normal use” can be, for example, 30 times, 50 times, 70 times, 100 times, 300 times, or 500 times, depending on the application for the lithium secondary battery. In addition, the “discharge capacity after the charging and discharging cycles not declining significantly relative to the first discharge capacity after the initial charging” depends on the application for the lithium secondary battery. For example, it may be 60% or more, 65% or more, 70% or more, 75% or more, 80% or more, or 85% or more of the first discharge capacity after the initial charging.

Anode Free Battery

The anode free battery in the embodiment includes a positive electrode current collector, a negative electrode, a separator that is disposed between the positive electrode current collector and the negative electrode, a positive electrode that is disposed between the positive electrode current collector and the separator and contains a positive electrode active material, and electrolytic solution, wherein the lithium secondary battery includes a layer containing an anion-absorbing conductive polymer between the positive electrode current collector and the separator. In the anode free battery in the embodiment, the metal ions that serve as charge carrier are not limited to the lithium ions in the lithium secondary batteries described above, and the metal ions may be sodium ions, calcium ions, magnesium ions, aluminum ions, and the like.

The anode free battery in the embodiment has the same configuration as the lithium secondary batteries described above and has the same effects as the lithium secondary batteries described above, except that the metal ions that serve as charge carrier are not limited to the lithium ions and may be sodium ions, calcium ions, magnesium ions, aluminum ions, and the like. Therefore, with the anode free battery in the embodiment, it is possible to provide an anode free battery that has high energy density and capacity, and has excellent cycle characteristics.

The negative electrode active material in the anode free battery means metal ions that act as a charge carrier in a battery, or a material that retains metal in the negative electrode, and the negative electrode active material may be rephrased as a host material for a metal element (typically, the metal). The positive electrode active material in the anode free battery means metal ions that act as a charge carrier in a battery, or a material that retains metal in the positive electrode, and the positive electrode active material may be rephrased as a host material for a metal element (typically, metal ions of the metal). As the negative electrode active material and the positive electrode active material in the anode free battery, any well-known materials can be used.

### EXAMPLES

The following is a more detailed description of the present invention with reference to examples and comparative examples. The present invention is not limited in any way by these examples.

### Example 1

A lithium secondary battery was produced as follows.

First, a 10 μm electrolytic Cu foil was washed with a solvent containing sulfamic acid, punched to a predetermined size (45 mm×45 mm), washed ultrasonically with ethanol, and then dried. Thereafter, the Cu foil was degreased, washed with pure water, and then immersed in a plating bath containing Sb ions. The surface of the Cu foil was electrolytically plated while the Cu foil was allowed to stand horizontally, thereby plating the surface of the Cu foil with Sb to be a metal layer having a thickness of 100 nm. The Cu foil was taken out from the plating bath, washed with ethanol, and washed with pure water. The Cu foil coated with the Sb thin film was used as a negative electrode.

As a separator, a separator having a thickness of 16 μm and a predetermined size (50 mm×50 mm), in which both sides of a 12 μm-thick polyethylene microporous film were coated with a 2 μm-thick polyvinylidene fluoride (PVdF), was prepared.

Polyaniline commercially available as a conductive polymer was dissolved in m-xylene to obtain a polymer solution. The polymer solution containing polyaniline was applied to one surface of the above-described separator and dried to form a polymer layer formed of polyaniline. The thickness of the polymer layer was 1.0 μm. The amount of the anion-absorbing conductive polymer was 8.0%, in terms of capacity ratio, relative to the total capacity of the positive electrode active material and the anion-absorbing conductive polymer.

A positive electrode was produced as follows. A mixture of 96 parts by mass LiNi_{0.85}Co_{0.12}Al_{0.03}O₂ positive electrode active material, 2 parts by mass carbon black conductive aid, and 2 parts by mass polyvinylidene fluoride (PVdF) binder was applied to one surface of 12 μm-thick Al foil positive electrode current collector, and press-molded. The resulting molded material was punched to a predetermined size (40 mm×40 mm) to obtain a positive electrode formed on the positive electrode current collector.

An electrolytic solution was prepared as follows. A solution obtained by mixing dimethoxyethane (DME) and 1,1,2,2-tetrafluoroethyl-2,2,2-trifluoroethyl ether (TFEE) at a volume ratio of 10:90 was used as a solvent, and a 1.25 M LiFSI solution was prepared by dissolving LiN(SO₂F)₂ (LiFSI) as an electrolyte.

The positive electrode formed on the positive electrode current collector, the separator on which the polymer layer was formed, and the negative electrode obtained as described above were laminated in this order to obtain a laminate as shown in FIG. 1. A 100 μm-thick Al terminal and a 100 μm-thick Ni terminal were connected to the positive electrode current collector and the negative electrode by ultrasonic welding, respectively, and then the laminate was inserted into a laminated outer casing. Next, the above-described electrolytic solution was injected into the outer casing. The outer casing was then sealed to obtain a lithium secondary battery.

### Examples 2 to 5

Lithium secondary batteries were obtained in the same manner as in Example 1, except that each anion-absorbing conductive polymer described in Table 1 was used instead of polyaniline when forming the polymer layer. As each anion-absorbing conductive polymer, a commercially available product was used, and the thickness of the polymer layer was set to be the same as that in Example 1.

### Examples 6 to 8

Lithium secondary batteries were obtained in the same manner as in Example 1, except that a 10 μm electrolytic Cu foil was used as the negative electrode without forming the Sb metal layer when producing the negative electrode, and each anion-absorbing conductive polymer described in Table 1 was used instead of polyaniline when forming the polymer layer. As each anion-absorbing conductive polymer, a commercially available product was used, and the thickness of the polymer layer was set to be the same as that in Example 1.

### Example 9

A Cu foil coated with an Sb thin film was prepared as a negative electrode in the same manner as in Example 1. In addition, the same separator and electrolytic solution as in Example 1 were prepared.

A positive electrode was produced as follows. A mixture of 85 parts by mass LiNi_{0.85}Co_{0.12}Al_{0.03}O₂ positive electrode active material, 2.0 parts by mass carbon black conductive aid, 3.0 parts by mass polyvinylidene fluoride (PVdF) binder, and 10 parts by mass of polyaniline anion-absorbing conductive polymer was applied to one surface of 12 μm-thick Al foil positive electrode current collector, and press-molded. The resulting molded material was punched to a predetermined size (40 mm×40 mm) to obtain a positive electrode formed on the positive electrode current collector. The amount of the anion-absorbing conductive polymer was 8.0%, in terms of capacity ratio, relative to the total capacity of the positive electrode active material and the anion-absorbing conductive polymer.

The positive electrode formed on the positive electrode current collector, the separator, and the negative electrode obtained as described above were laminated in this order to obtain a laminate as shown in FIG. 4. Using the resulting laminate, a lithium secondary battery was obtained in the same manner as in Example 1.

### Comparative Example 1

A lithium secondary battery was obtained in the same manner as in Example 1, except that the polymer layer was not formed.

Evaluation of Energy Density and Cycle Characteristics

The energy density and cycle characteristics of the lithium secondary batteries produced in the examples and the comparative examples were evaluated as follows.

The produced lithium secondary battery was charged at 7 mA until the voltage reached 4.2 V (initial charging), and then discharged at 7 mA until the voltage reached 3.0 V (“initial discharging”). Then, a cycle of charging at 35 mA until the voltage reached 4.2 V and then discharging at 35 mA until the voltage reached 3.0 V was repeated at a temperature of 25° C. Table 1 shows the capacity (“initial capacity”) obtained from the initial discharging for each example. For the examples, the number of cycles (referred to as “Number of cycles at 80%” in the table) when the discharge capacity reached 80% of the initial capacity is shown in Table 1.

TABLE 1

| | | | | | Initial | Number of cycles |
|---|---|---|---|---|---|---|
| | Negative | | Polymer | Positive | capacity | at 80% |
| | electrode | Separator | layer | electrode | (mAh) | (times) |
| Example | Cu-Sb | PVdF-PE-PVdF | PAn | NCA | 69 | 162 |
| 1 | | | | | | |
| Example | Cu-Sb | PVdF-PE-PVdF | PTp | NCA | 72 | 178 |
| 2 | | | | | | |
| Example | Cu-Sb | PVdF-PE-PVdF | PPP | NCA | 72 | 173 |
| 3 | | | | | | |
| Example | Cu-Sb | PVdF-PE-PVdF | PTv | NCA | 74 | 179 |
| 4 | | | | | | |
| Example | Cu-Sb | PVdF-PE-PVdF | PF | NCA | 71 | 174 |
| 5 | | | | | | |
| Example | Cu | PVdF-PE-PVdF | Ppy | NCA | 74 | 172 |
| 6 | | | | | | |
| Example | Cu | PVdF-PE-PVdF | PPv | NCA | 70 | 175 |
| 7 | | | | | | |
| Example | Cu | PVdF-PE-PVdF | PEDOT | NCA | 71 | 181 |
| 8 | | | | | | |
| Example | Cu-Sb | PVdF-PE-PVdF | — | PAn-NCA | 67 | 167 |
| 9 | | | | | | |
| Comp. | Cu-Sb | PVdF-PE-PVdF | — | NCA | 65 | 130 |
| Example | | | | | | |
| 1 | | | | | | |

In Table 1, “PAn” means polyaniline, “Ppy” means polypyrrole, “PTp” means polythiophene, “PEDOT” means polyethylenedioxythiophene, “PPP” means poly-p-phenylene, “PF” means polyfluorene, “PPv” means poly-p-phenylenevinylene, “PTv” means polythienylenevinylene, “PE” means a polyethylene microporous film, and NCA means LiNi_{0.85}Co_{0.12}Al_{0.03}O₂. In addition, “-” in the column of the polymer layer means that the polymer layer was not provided.

From Table 1, it is clear that Examples 1 to 9 including the layer containing the anion-absorbing conductive polymer between positive electrode current collector and the separator have higher initial capacity and number of cycles at 80%, and are excellent in capacity and cycle characteristics as compared with Comparative Example 1 not including the layer.

### INDUSTRIAL APPLICABILITY

Because the lithium secondary battery of the present invention has high energy density and capacity and have excellent cycle characteristics, it has industrial applicability as a power storage device used in various applications.

What is claimed is:

1. A lithium secondary battery comprising:
a positive electrode current collector;
a negative electrode that is free of a negative electrode active material;
a separator that is disposed between the positive electrode current collector and the negative electrode;
a positive electrode that is disposed between the positive electrode current collector and the separator and comprises a positive electrode active material; and
electrolytic solution,
wherein the lithium secondary battery comprises a layer comprising an anion-absorbing conductive polymer between the positive electrode current collector and the separator.

2. A lithium secondary battery comprising:
a positive electrode current collector;
a negative electrode that is free of a negative electrode active material;
a solid electrolyte that is disposed between the positive electrode current collector and the negative electrode; and
a positive electrode that is disposed between the positive electrode current collector and the solid electrolyte and comprises a positive electrode active material,
wherein the lithium secondary battery comprises a layer comprising an anion-absorbing conductive polymer between the positive electrode current collector and the solid electrolyte.

3. The lithium secondary battery according to claim 1, wherein a polymer layer comprising the anion-absorbing conductive polymer is disposed between the positive electrode current collector and the positive electrode.

4. The lithium secondary battery according to claim 1, wherein a polymer layer comprising the anion-absorbing conductive polymer is disposed on a surface of the positive electrode, opposite to the positive electrode current collector.

5. The lithium secondary battery according to claim 1, wherein the positive electrode comprises the anion-absorbing conductive polymer.

6. The lithium secondary battery according to claim 1, wherein an amount of the anion-absorbing conductive polymer in the lithium secondary battery is 1% or more and 15% or less, in terms of capacity ratio, relative to a total capacity of the positive electrode active material and the anion-absorbing conductive polymer.

7. The lithium secondary battery according to claim 1, wherein, in the lithium secondary battery, charging and discharging are performed by depositing lithium metal on a surface of the negative electrode and electrolytically dissolving the deposited lithium.

8. The lithium secondary battery according to claim 1, wherein the negative electrode is an electrode consisting of at least one selected from the group consisting of Cu, Ni, Ti, Fe, other metals that do not react with Li, alloys of these metals, and stainless steel (SUS).

9. The lithium secondary battery according to claim 1, wherein no lithium foil is formed on a surface of the negative electrode before initial charging.

10. The lithium secondary battery according to claim 1, wherein an energy density is 350 Wh/kg or more.

11. The lithium secondary battery according to claim 2, wherein a polymer layer comprising the anion-absorbing conductive polymer is disposed between the positive electrode current collector and the positive electrode.

12. The lithium secondary battery according to claim 2, wherein a polymer layer comprising the anion-absorbing conductive polymer is disposed on a surface of the positive electrode, opposite to the positive electrode current collector.

13. The lithium secondary battery according to claim 2, wherein the positive electrode comprises the anion-absorbing conductive polymer.

14. The lithium secondary battery according to claim 2, wherein an amount of the anion-absorbing conductive polymer in the lithium secondary battery is 1% or more and 15% or less, in terms of capacity ratio, relative to a total capacity of the positive electrode active material and the anion-absorbing conductive polymer.

15. The lithium secondary battery according to claim 2, wherein, in the lithium secondary battery, charging and discharging are performed by depositing lithium metal on a surface of the negative electrode and electrolytically dissolving the deposited lithium.

16. The lithium secondary battery according to claim 2, wherein the negative electrode is an electrode consisting of at least one selected from the group consisting of Cu, Ni, Ti, Fe, other metals that do not react with Li, alloys of these metals, and stainless steel (SUS).

17. The lithium secondary battery according to claim 2, wherein no lithium foil is formed on a surface of the negative electrode before initial charging.

18. The lithium secondary battery according to claim 2, wherein an energy density is 350 Wh/kg or more.

19. An anode free battery comprising:
a positive electrode current collector;
a negative electrode;
a separator that is disposed between the positive electrode current collector and the negative electrode;
a positive electrode that is disposed between the positive electrode current collector and the separator and comprises a positive electrode active material; and
an electrolytic solution,
wherein the lithium secondary battery comprises a layer comprising an anion-absorbing conductive polymer between the positive electrode current collector and the separator.
